(19) United States
(12) Patent Application Publication
(10) Pub. No.: US 2009/0095542 A1
(43) Pub. Date: Apr. 16, 2009

(54) TOUCH SENSOR AND OPERATING METHOD THEREOF

(75) Inventors: Byung-Joon Moon, Gyeonggi-do (KR); Bang-Won Lee, Gyeonggi-do (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/297,401

(22) PCT Filed: May 1, 2007
(86) PCT No.: PCT/KR2007/002134

§ 371 Date: Oct. 16, 2008

(30) Foreign Application Priority Data
Jun. 22, 2006 (KR) 10-2006-0056539

(51) Int. Cl. G06F 3/044

(52) U.S. Cl. 178/18.06; 341/33

(57) ABSTRACT

Provided are a touch sensor and a method of operating the same. The touch sensor includes: a pulse signal generator for generating a pulse signal of which pulse width is calibrated in response to a control code; a pulse signal transmitter for transmitting the pulse signal when a touch object is out of contact with a touch pad and stopping transmitting the pulse signal when the touch object is in contact with the touch pad; a pulse signal detector for detecting the pulse signal transmitted through the pulse signal transmitter; and a controller recognizing a non-contact state and adjusting the control code to calibrate the pulse width of the pulse signal when the pulse signal detector detects the pulse signal. In the above-described configuration, the contact of the touch object with the touch pad can be sensed more precisely, and the occurrence of a malfunction in the touch sensor due to changed operating conditions can be prevented. As a result, the operating reliability of the touch sensor can be enhanced.

### TECHNICAL FIELD

The present invention relates to a touch sensor, and more particularly, to a touch sensor capable of sensing whether or not a touch object is in contact with the touch sensor using an electrostatic capacitance of the touch object.

### BACKGROUND ART

Korean Patent Application No. 2005-23382 discloses a touch sensor as shown in FIG. 1, which senses whether or not a touch object is in contact with the touch sensor by varying a difference in delay time between a touch signal and a reference signal using the electrostatic capacitance of the touch object.

Referring to FIG. 1, the touch sensor includes a reference signal generator 10, a first signal generator 21, a second signal generator 22, a touch signal generator 30, and a low pass filter (LPF) 40. Specifically, the reference signal generator 10 generates a reference signal ref_sig. The first signal generator 21, which includes a resistor R11 and a capacitor CAP, delays the reference signal ref_sig by a constant delay time irrespective of whether or not the touch object is in contact with the touch sensor, and generates a first signal sig1. The second signal generator 22, which includes a resistor R12 and a touch pad PAD, delays the reference signal ref_sig by a variable delay time according to the electrostatic capacitance of the touch object and generates a second signal sig2. The touch signal generator 30, which includes a D-flip-flop, latches the second signal sig2 in response to the first signal sig1 and generates a touch signal con_sig. The LPF 40 filters the touch signal con_sig and outputs a filtered signal.

The touch signal generator 30 generates a touch signal con_sig having a first level when the touch object is brought into contact with the touch pad PAD and the second signal sig2 has a longer delay time than the first signal sig1. On the other hand, the touch signal generator 30 generates a touch signal con_sig having a second level when the touch object is out of contact with the touch pad PAD and the second signal sig2 has a shorter delay time than the first signal sig1.

As described above, the touch sensor of FIG. 1 varies a difference in delay time between the first signal sig1 and the second signal sig2 depending on whether or not the touch object is in contact with the touch pad PAD.

However, when the touch pad PAD has poor touch sensitivity or the touch object has very small electrostatic capacitance, a difference in delay time between the first signal sig1 and the second signal sig2 cannot be sufficiently varied, so that a malfunction may occur in the touch sensor.

Furthermore, the impedance of a circuit device included in each of the first and second signal generators 21 and 22 and a delay difference between the first and second signals sig1 and sig2 may vary with operating conditions of the touch sensor, such as an operating power supply voltage and the temperature and humidity of the atmosphere.

However, although the impedance of the circuit device included in each of the first and second signal generators 21 and 22 is changed according to the operating conditions, the conventional touch sensor provides no calibration element. As a result, the operating characteristics of the touch sensor are variable according to the operating conditions and, what is worse, a malfunction may occur in the touch sensor.

### DISCLOSURE OF INVENTION

### Technical Problem

The present invention is directed to a touch sensor and a method of operating the same in which the contact of a touch object with the touch sensor is precisely sensed.

Also, the present invention is directed to a touch sensor and a method of operating the same in which the occurrence of a malfunction due to changed operating conditions may be prevented.

### Technical Solution

One aspect of the present invention provides a touch sensor including: a pulse signal generator for generating a pulse signal of which pulse width is calibrated in response to a control code; a pulse signal transmitter for transmitting the pulse signal when a touch object is out of contact with a touch pad and stopping transmitting the pulse signal when the touch object is in contact with the touch pad; a pulse signal detector for detecting the pulse signal transmitted through the pulse signal transmitter; and a controller for recognizing a non-contact state and adjusting the control code to calibrate the pulse width of the pulse signal when the pulse signal detector detects the pulse signal.

In an embodiment of the present invention, the pulse signal transmitter may include: a resistor; and the touch pad charged or discharged with the pulse signal according to a resistance of the resistor and an electrostatic capacitance of the touch object to inhibit the transmission of the pulse signal.

In another embodiment, the pulse signal transmitter may include: a variable resistor of which a resistance varies with the control code; and the touch pad charged or discharged with the pulse signal according to the varied resistance of the variable resistor and the electrostatic capacitance of the touch object to inhibit the transmission of the pulse signal when the touch object is in contact with the touch sensor.

In an embodiment of the present invention, the pulse signal generator may include: a clock signal generator for generating a clock signal; and a counter of which a counting value is set according to the control code and counting by the counting value in response to the clock signal to vary the pulse width of the pulse signal.

In another embodiment, the pulse signal generator may include: a clock signal generator for generating a clock signal; a signal delay unit for varying the delay time of the clock signal according to the control code; an inverter for inverting an output signal of the signal delay unit; and a logic gate for performing a logic AND operation on the clock signal and an output signal of the inverter to generate the pulse signal having a pulse width corresponding to the delay time of the clock signal.

Another aspect of the present invention provides a method of operating a touch sensor. The method includes: generating a pulse signal having a predetermined pulse width; transmitting the pulse signal when a touch object is out of contact with a touch pad and stopping transmitting the pulse signal when the touch object is in contact with the touch pad; recognizing a non-contact state when the pulse signal is transmitted and recognizing a contact state when the pulse signal is not transmitted; and calibrating the pulse width of the pulse signal in the non-contact state.

In an embodiment of the present invention, calibrating the pulse width of the pulse signal in the non-contact state may include: obtaining a critical pulse width at which the pulse signal is not transmitted by gradually decreasing the pulse width of the pulse signal from the maximum value; obtaining a calibrated pulse width by adding a margin pulse width to the critical pulse width when a difference between the current critical pulse width and a critical pulse width obtained in the previous calibration operation is within the permitted limit; and calibrating the pulse width of the pulse signal to the calibrated pulse width.

In another embodiment of the present invention, calibrating the pulse width of the pulse signal in the non-contact state may include: obtaining a critical pulse width at which the pulse signal is not transmitted by gradually decreasing the pulse width of the pulse signal from the sum of a pulse width obtained in the previous calibration operation and the permitted limit; obtaining a calibrated pulse width by adding a margin pulse width to the critical pulse width when a difference between the current critical pulse width and a critical pulse width obtained in the previous calibration operation is within the permitted limit; and calibrating the pulse width of the pulse signal to the calibrated pulse width.

In yet another embodiment of the present invention, calibrating the pulse width of the pulse signal in the non-contact state may include: obtaining a critical pulse width at which the pulse signal is not transmitted by increasing and decreasing the pulse width of the pulse signal using a successive approximation method; obtaining a calibrated pulse width by adding a margin pulse width to the critical pulse width when a difference between the current critical pulse width and a critical pulse width obtained in the previous calibration operation is within the permitted limit; and calibrating the pulse width of the pulse signal to the calibrated pulse width.

### Advantageous Effects

As described above, a touch sensor is capable of confirming if a touch object is in contact with a touch pad depending on whether a pulse signal is transmitted or not, so that the touch sensor can perform a touch sensing operation more precisely. Also, the pulse width of the pulse signal is periodically adjusted to operating conditions, thus preventing the occurrence of a malfunction in the touch sensor due to changed operating conditions. As a result, the operating reliability of the touch sensor can be enhanced.

### BRIEF DESCRIPTION OF THE DRAWINGS

FIG. 1 is a detailed circuit diagram of a conventional touch sensor;

FIG. 2 is a block diagram of a touch sensor according to an exemplary embodiment of the present invention;

FIG. 3 is a detailed circuit diagram of a touch sensor according to an exemplary embodiment of the present invention;

FIG. 4 is a detailed circuit diagram of a touch sensor according to another exemplary embodiment of the present invention;

FIG. 5 shows a correlation between the delay time of a signal delay unit of FIG. 4 and the pulse width of a pulse signal;

FIG. 6 is a detailed circuit diagram of a touch sensor according to yet another exemplary embodiment of the present invention;

FIG. 7 is a detailed circuit diagram of a signal delay unit SIGD according to an exemplary embodiment of the present invention;

FIG. 8 is a circuit diagram of a pulse signal transmitter according to another exemplary embodiment of the present invention;

FIG. 9 is a flowchart illustrating a method of operating a touch sensor according to an exemplary embodiment of the present invention;

FIG. 10 is a flowchart illustrating a calibration operation (step S10) of FIG. 9 according to an exemplary embodiment of the present invention;

FIG. 11 is a flowchart illustrating a calibration operation (step S10) of FIG. 9 according to another exemplary embodiment of the present invention;

FIG. 12 is a flowchart illustrating a calibration operation (step S10) of FIG. 9 according to yet another exemplary embodiment of the present invention; and

FIG. 13 is a graph illustrating a method of finding a critical pulse width in the calibration operation of FIG. 12.

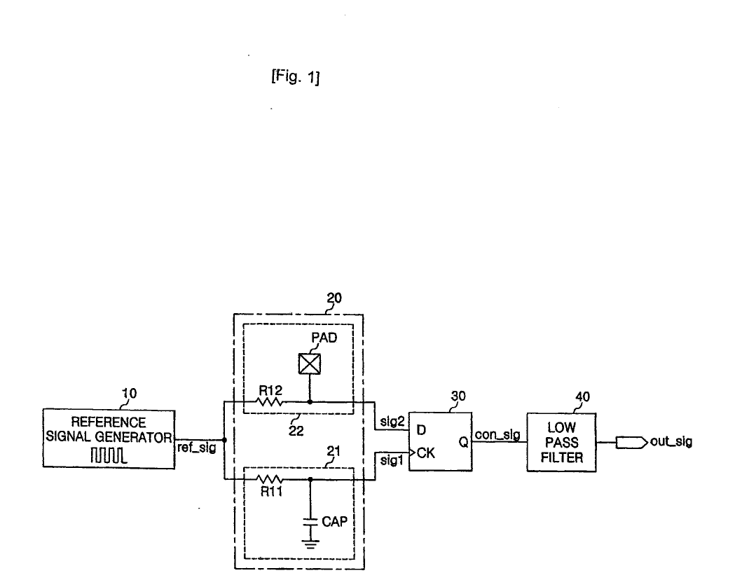

### MODE FOR THE INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

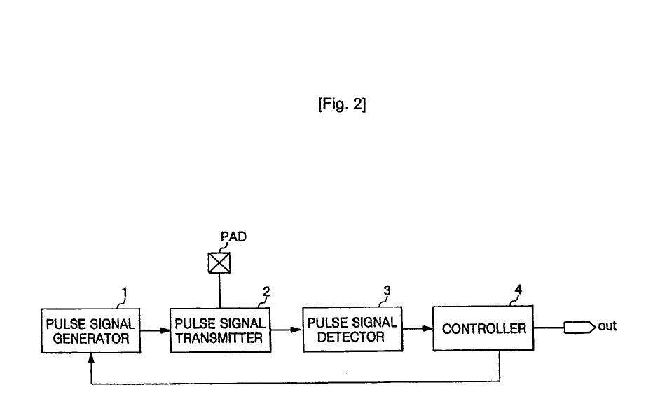

FIG. 2 is a block diagram of a touch sensor according to an exemplary embodiment of the present invention.

Referring to FIG. 2, the touch sensor may include a pulse signal generator 1, a pulse signal transmitter 2, a pulse signal detector 3, and a controller 4.

Specifically, the pulse signal generator 1 receives a code value of a control code “code” from the controller 4, sets the pulse width of a pulse signal “pul” according to the code value of the control code “code”, and generates the pulse signal “pul” with the set pulse width.

The pulse transmitter 2 includes a touch pad PAD in which a touch object having a predetermined electrostatic capacitance contacts. The pulse transmitter 2 directly transmits the pulse signal “pul” to the pulse signal detector 3 when the touch object is out of contact with the touch pad PAD, while the pulse transmitter 2 transmits the pulse signal “pul” not to the pulse signal detector 3 but to the touch pad PAD when the touch object is in contact with the touch pad PAD.

In this case, the touch object may be any object having a predetermined electrostatic capacitance, for example, a human body in which a lot of charges may be accumulated.

The pulse signal detector 3 receives the pulse signal “pul” from the pulse signal transmitter 2, detects the pulse signal “pul”, and transmits the detection result to the controller 4.

The controller 4 generates an output signal “out” based on the detection result of the pulse signal detector 3 and outputs the output signal “out” to an external apparatus, so that the external apparatus can be informed of whether the touch object is in contact with the touch pad PAD or not. Also, the controller 4 periodically performs a calibration operation such that the pulse width of the pulse signal “pul” is adjustable to the current operating conditions in a non-contact state.

In FIG. 2, the impedance of a circuit device included in each of the pulse signal generator 1 and the pulse signal transmitter 2 of the touch sensor and the touch sensitivity of the touch pad PAD may vary with operating conditions, such as an operating power supply voltage and the temperature and humidity of the atmosphere. Thus, the range of the pulse width in which the pulse signal detector 3 can detect the pulse signal “pul” transmitted by the pulse signal transmitter 2 also varies with the operating conditions of the touch sensor.

Therefore, the controller 4 of the present invention varies the pulse width of the pulse signal according to the operating conditions so that the pulse signal detector 3 can always precisely detect the pulse signal “pul” transmitted by the pulse signal transmitter 2, thus preventing the occurrence of a malfunction in the touch sensor due to variable operating conditions.

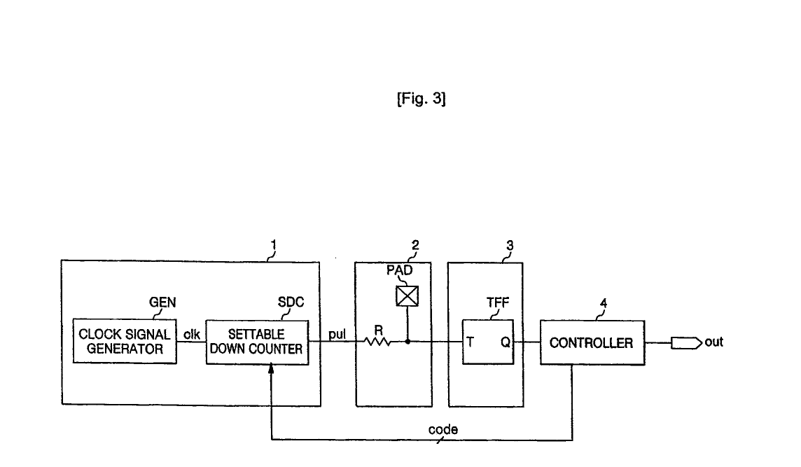

FIG. 3 is a detailed circuit diagram of a touch sensor according to an exemplary embodiment of the present invention.

Referring to FIG. 3, the pulse signal generator 1 may include a clock signal generator GEN and a settable down counter SDC, the pulse signal transmitter 2 includes a resistor R and a touch pad PAD, and the pulse signal detector 3 is embodied by a T-flip-flop TFF.

The clock signal generator GEN generates a clock signal “clk” and transmits the clock signal “clk” to the settable down counter SDC.

The settable down counter SDC generates a pulse signal “pul” of which pulse width varies according to a code value of a control code “code” transmitted from the controller 4. Specifically, the settable down counter SDC of which a count value is set according to the code value of the control code “code”, leads the pulse signal “pul” to make an upward (downward) transition at the start of a counting operation, and leads the pulse signal “pul” to make a downward (upward) transition at the end of the counting operation, so that the pulse width of the pulse signal “pul” may vary with the code value of the control code “code”.

The resistor R has a predetermined resistance and obtains the electrostatic capacitance of a touch object that is in contact with the touch pad PAD. Thus, when the touch object is in contact with the touch pad PAD, the resistor R and the touch pad PAD are charged or discharged with the pulse signal “pul” according to the resistance of the resistor R and the electrostatic capacitance of the touch object, and the transmission of the pulse signal “pul” to the T-flip-flop TFF is inhibited. On the other hand, when the touch object is out of contact with the touch pad PAD, the resistor R and the touch pad PAD are neither charged nor discharged with the pulse signal “pul”, and the pulse signal “pul” is transmitted to the T-flip-flop TFF.

When receiving the pulse signal “pul”, the T-flip-flop TFF is synchronized with a rising edge or falling edge of the pulse signal “pul” and toggles an output signal. When receiving no pulse signal “pul”, the T-flip-flop TFF does not toggle the output signal.

When the T-flip-flop TFF outputs the toggled output signal, the controller 4 externally outputs an output signal “out” for informing a user of non-contact of the touch object with the touch pad PAD. When the T-flip-flop TFF does not output the toggled output signal, the controller 4 externally outputs an output signal “out” for informing the user of contact of touch object with the touch pad PAD.

As described above, the touch sensor of FIG. 3 allows or inhibits the transmission of the pulse signal “pul” depending on whether the touch object contacts the touch pad PAD, so that a user can easily and precisely confirm the contact or non-contact of the touch object with the touch pad PAD.

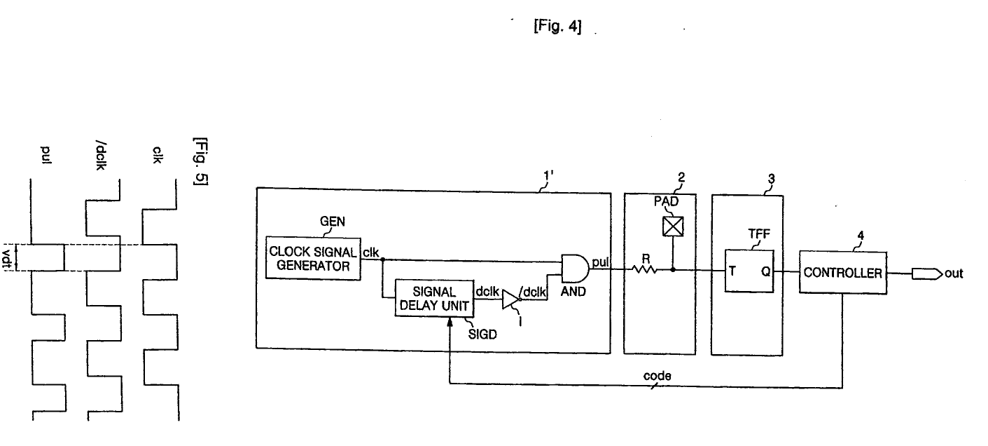

FIG. 4 is a detailed circuit diagram of a touch sensor according to another exemplary embodiment of the present invention.

Referring to FIG. 4, a pulse signal transmitter 2, a pulse signal detector 3, and a controller 4 are respectively the same as those of FIG. 3, but a pulse signal generator 1′ includes a clock signal generator GEN, a signal delay unit SIGD, an inverter I, and an AND gate AND, unlike FIG. 3.

In FIG. 4, the same reference numerals are used to denote the same elements as in FIG. 3 and thus, a detailed description of the same elements will be omitted here.

The clock signal generator GEN generates a clock signal “clk” and transmits the clock signal “clk” to each of the signal delay unit SIGD and the AND gate AND.

The signal delay unit SIGD varies the delay time of the clock signal “clk” in response to a code value of a control code “code” transmitted from the controller 4.

The inverter I receives a delayed clock signal “dclk” from the signal delay unit SIGD, inverts the delayed clock signal “dclk”, and outputs an inverted clock signal “/dclk”.

The AND gate AND performs a logic AND operation on the clock signal “clk” transmitted from the clock signal generator GEN and the clock signal “/dclk” output from the inverter I and generates a pulse signal “pul” having a pulse width corresponding to the delay time of the signal delay unit SIGD.

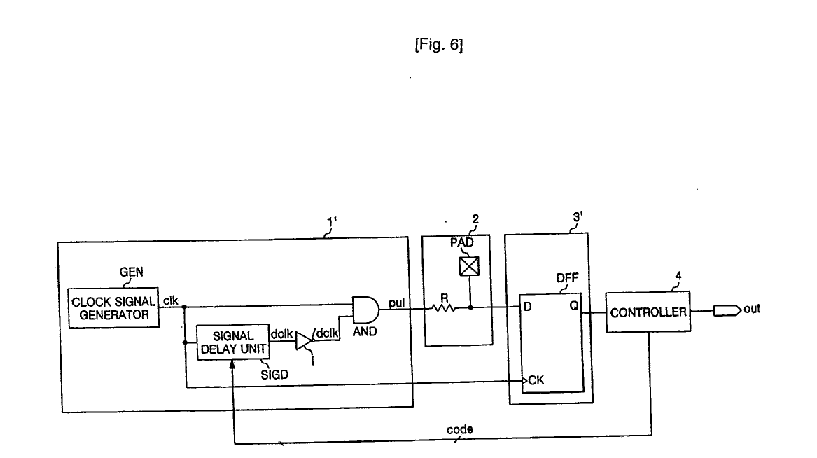

For example, as illustrated in FIG. 5, when the delay time of the signal delay unit SIGD is “vdt”, the delay time of the clock signal “/dclk” transmitted through the signal delay unit SIGD and the inverter I also becomes “vdt”. Thus, the AND gate AND performs a logic AND operation on the clock signals “clk” and “/dclk” and generates a pulse signal “pul” having a pulse width corresponding to the delay time “vdt” of the signal delay unit SIGD.

As described above, in the touch sensor of FIG. 4, the pulse signal generator 1′, which includes the clock signal generator GEN, the signal delay unit SIGD, the inverter I, and the AND gate AND, generates the pulse signal “pul” of which pulse width varies with the code value of the control code “code” so that the pulse signal transmitter 2, the pulse signal detector 3, and the controller 4 can operate in the same manner as described with reference to FIG. 3.

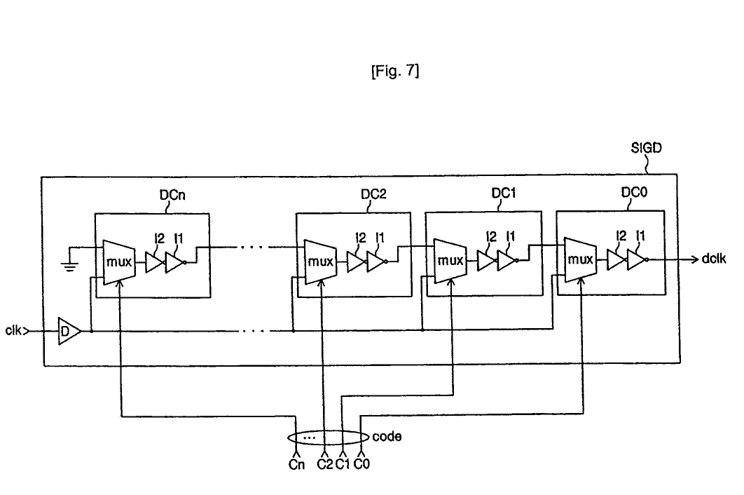

FIG. 6 is a detailed circuit diagram of a touch sensor according to yet another exemplary embodiment of the present invention.

Referring to FIG. 6, a pulse signal generator 1′ and a pulse signal transmitter 2 are respectively the same as those of FIG. 4, but a pulse signal detector 3′ is embodied by a D-flip-flop DFF.

In FIG. 6, the same reference numerals are used to denote the same elements as in FIG. 4 and thus, a detailed description of the same elements will be omitted here.

The D-flip-flop DFF receives a clock signal “clk” output from a clock signal generator GEN as a clock, and receives a pulse signal “pul” as data. When receiving the pulse signal “pul”, the D-flip-flop DFF is synchronized with a falling edge (or rising edge) of the clock signal “clk”, latches the pulse signal “pul”, and generates a high signal. When receiving no pulse signal “pul”, the D-flip-flop DFF does not latch any signal and generates a low signal.

Thus, a controller 4 confirms non-contact of a touch object with a touch pad PAD when the D-flip-flop DFF generates the high signal, and confirms contact of the touch object with the touch pad PAD when the D-flip-flop DFF generates the low signal.

As described above, in the touch sensor of FIG. 6, the D-flip-flop DFF may vary the level of the output signal depending on whether or not the touch object contacts the touch pad PAD, so that the controller 4 can easily confirm the contact or non-contact of the touch object with the touch pad PAD.

FIG. 7 is a detailed circuit diagram of a signal delay unit SIGD according to an exemplary embodiment of the present invention.

Referring to FIG. 7, the signal delay unit SIGD includes a driver D, which is connected to a signal input terminal “clk”, and a plurality of delay cells DC1 to DCn, which are connected in series between the driver D and a signal output terminal “dclk”, and each of the delay cells DC1 to DCn includes a multiplexer “mux” and inverters I1 and I2.

The driver D buffers a clock signal “clk” and transmits the buffered signal to the delay cells DC1 to DCn.

The multiplexers “mux” select the delay cells (e.g., the delay cells DC2 to DC0) to perform delay operations in response to code values c0 to cn of a control code “code”, and the multiplexers “mux” and the inverters I1 and I2 included in the selected delay cells DC2 and DC0 delay the clock signal “clk” by a predetermined delay time.

As described above, the signal delay unit SIGD varies the number of delay cells to delay the clock signal “clk” according to the code value of the control code “code” and varies the delay time of the clock signal “clk”, so that the inverter I and an AND gate AND can generate a pulse signal “pul” having a pulse width corresponding to the delay time of the clock signal “clk”.

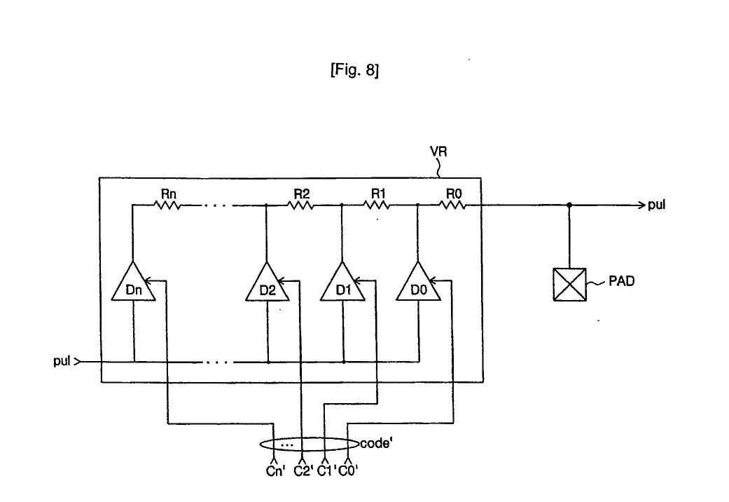

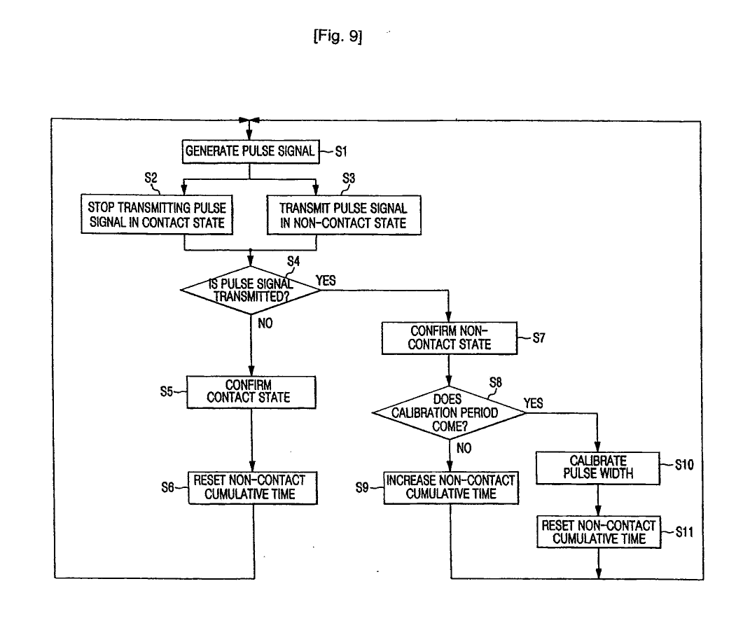

Also, the touch sensor according to the present invention may employ a variable resistor of FIG. 8 instead of the resistor R included in the pulse signal transmitter 2, so that the controller 4 can control the resistance of the variable resistor to vary the touch sensitivity of the touch pad PAD.

FIG. 8 is a circuit diagram of a pulse signal transmitter according to another exemplary embodiment of the present invention.

Referring to FIG. 8, the pulse signal transmitter includes a variable resistor VR and a touch pad PAD. The variable resistor VR includes a plurality of drivers D0 to Dn, which are respectively connected between a pulse input terminal “pul” and a plurality of corresponding resistors R0 to Rn, and the plurality of resistors R0 to Rn are connected in series to the touch pad PAD.

In this case, a controller (not shown) further provides a control code code′ for controlling the resistance of the variable resistor VR in addition to a control code “code” for varying the pulse width of the pulse signal “pul” during a calibration operation.

Thus, the variable resistor VR determines the number of resistors to which the pulse signal “pul” is transmitted through the drivers D0 to Dn, of which operations are controlled in response to code values c0′ to cn′ of the control code code′. In other words, the variable resistor VR varies the entire resistance according to the code value of the control code code′ and also varies an RC time constant with the electrostatic capacitance of the touch pad PAD.

Thus, charging/discharging characteristics of the touch pad PAD vary with the RC time constant, which is varied by the variable resistor VR, and the touch sensitivity of the touch pad PAD finally depends on the varied charging/discharging characteristics thereof.

Therefore, the pulse signal transmitter of FIG. 8 may vary the touch sensitivity of the touch pad PAD according to the code value of the control code code′ transmitted from the controller 4.

As described above, the touch sensor according to the present invention may vary not only the pulse width of the pulse signal “pul” but also the touch sensitivity of the touch pad PAD to the touch object according to the current operating conditions, thus enhancing the preciseness of a calibration operation.

FIG. 9 is a flowchart illustrating a method of operating a touch sensor according to an exemplary embodiment of the present invention.

When the touch sensor starts its operation, the pulse signal generator 1 generates a pulse signal “pul” having a predetermined pulse width and outputs the pulse signal “pul” to the pulse signal transmitter 2 in step S1.

When a touch object is brought into contact with a touch pad PAD, the pulse signal transmitter 2 stops the transmission of the pulse signal “pul” in step S2. When the touch object is out of contact with the touch pad PAD, the pulse signal transmitter 2 transmits the pulse signal “pul” to the pulse signal detector 3 in step S3.

Then, the controller 4 confirms if the pulse signal “pul” is transmitted through the pulse signal detector 3 in step S4. As a result, when the pulse signal “pul” is not transmitted, the controller 4 informs a user or an external apparatus that the touch object contacts the touch pad PAD in step S5. Thereafter, the controller 4 resets a “non-contact cumulative time” in step S6 and returns to step S1 to perform a new touch sensing operation.

On the other hand, when it is confirmed in step S4 that the pulse signal “pul” is transmitted, the controller 4 informs the external apparatus that the touch object is out of contact with the touch pad PAD in step S7 and confirms if a calibration period comes in step S8.

As a result, when it is confirmed in step S8 that the calibration period has not come yet, the controller 4 increases the current “non-contact cumulative time” as much as one unit in step S9 and returns to step S1 to perform a new touch sensing operation.

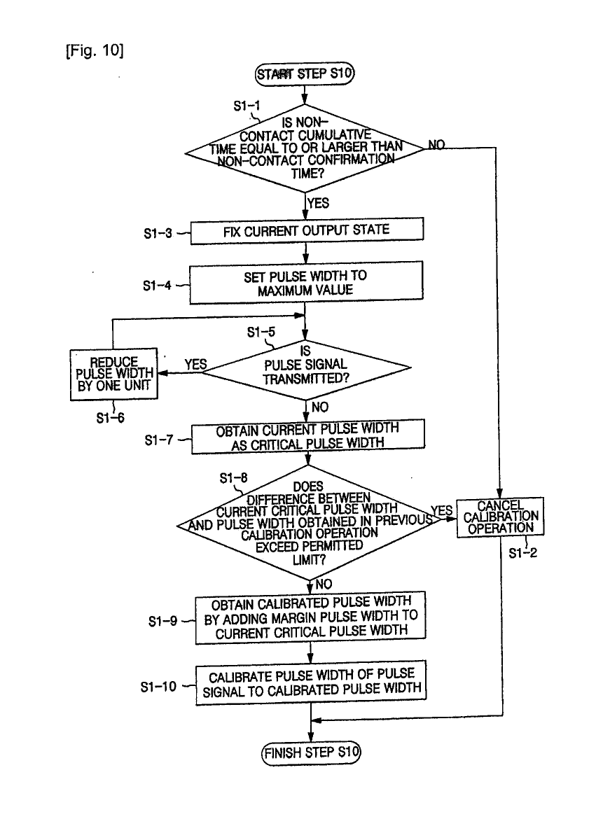

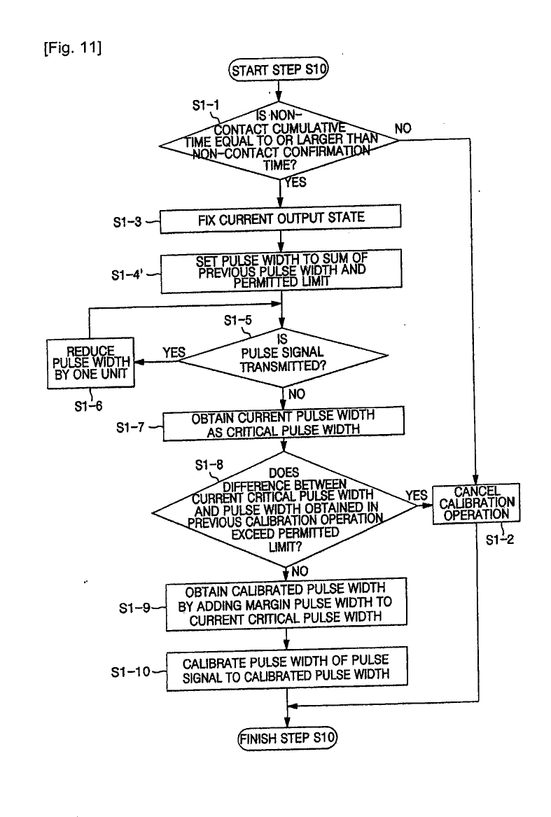

On the other hand, when it is confirmed in step S8 that the calibration period has come, the controller 4 performs a calibration operation such that the pulse width of the pulse signal “pul” is adjustable to the current operating conditions in step S10. The calibration of the pulse signal “pul” in step S10 will be described in more detail with reference to FIGS. 10 through 12.

When step 10 is finished, the controller 4 resets the current “non-contact cumulative time” and returns to step S1 to perform a new touch sensing operation using the pulse signal “pul” having a calibrated pulse width.

FIG. 10 is a flowchart illustrating a calibration operation (step S10) of FIG. 9. In FIG. 10, a pulse width appropriate for the current operating conditions may be obtained by gradually decreasing the pulse width of the pulse signal “pul” from the maximum value.

First, the controller 4 confirms if a “non-contact cumulative time” is equal to or larger than a “non-contact confirmation time” in step S1-1 in order to confirm if the current operating conditions are conditions under which the calibration of a pulse signal “pul” is normally performed (namely, if the touch object is out of contact with the touch pad PAD).

When the “non-contact cumulative time” is less than “the non-contact confirmation time” the controller 4 confirms that the touch object is in contact with the touch pad PAD and cancels the calibration operation in step S1-2 and ends the control sequence.

On the other hand, when the “non-contact cumulative time” is equal to or larger than the “non-contact confirmation time” the controller 4 confirms that the touch object is out of contact with the touch pad for a predetermined duration of time, and fixes the current output state in step S1-3 such that any malfunction does not occur in an external apparatus due to an output signal of the touch sensor during the calibration operation.

Thereafter, the controller 4 sets the pulse width of the pulse signal “pul” to the maximum value in step S1-4 and confirms if the pulse signal “pul” is transmitted through the pulse signal transmitter 2 to the controller 4 in step S1-5.

When the pulse signal “pul” is transmitted, the pulse width of the pulse signal “pul” is reduced by one unit in step S1-6 and the controller 4 returns to step S1-5. Thus, the pulse width of the pulse signal “pul” is gradually reduced until the pulse signal “pul” is not transmitted.

When the pulse signal “pul” is not transmitted, the controller 4 obtains the current pulse width as a critical pulse width in step S1-7 and confirms if a difference between the current critical pulse width and a critical pulse width obtained in the previous calibration operation exceeds a permitted limit in step S1-8. Here, the permitted limit is a value that can be determined by a user to confirm if the calibration of the pulse signal “pul” is normally performed.

When the difference between the current critical pulse width and the critical pulse width obtained in the previous calibration operation exceeds the permitted limit, the controller 4 confirms that the calibration condition is not satisfied and cancels the calibration operation in step S1-2 and ends the control sequence.

On the other hand, when the difference between the current critical pulse width and the critical pulse width obtained in the previous calibration operation is within the permitted limit, the controller 4 confirms that the calibration operation is performed under normal conditions and obtains a calibrated pulse width appropriate for the current operating conditions in step S1-9 by adding a margin pulse width to the current critical pulse width. Here, the margin pulse width is a value that can be set by a user based on the touch sensitivity of the touch pad PAD. Thus, the calibrated pulse width becomes the minimum pulse width that enables the pulse signal detector 3 to detect if the pulse signal “pul” is transmitted under the current operating conditions.

Thereafter, the controller 4 calibrates the pulse signal “pul” to the calibrated pulse width in step S1-10, ends the calibration operation, and enters step S11 of FIG. 9.

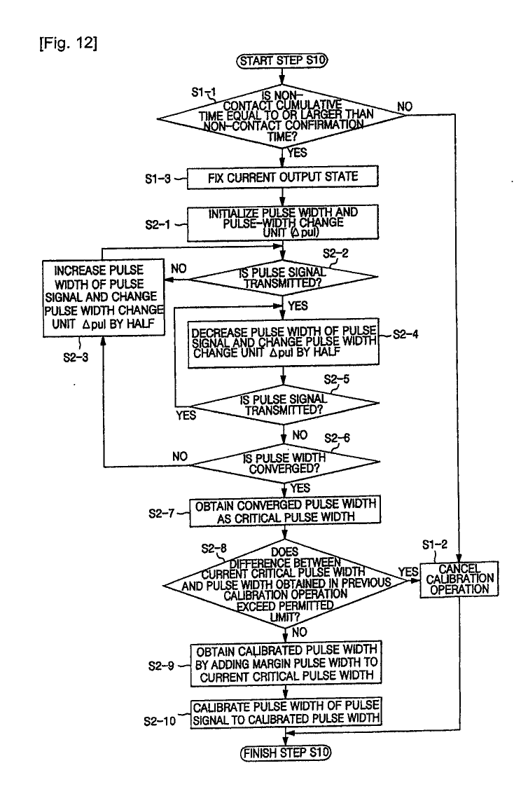

FIG. 11 is a flowchart illustrating a calibration operation (step S10) of FIG. 9 according to another exemplary embodiment of the present invention.

In FIG. 11, a pulse width appropriate for the current operating conditions may be obtained by gradually decreasing the pulse width of the pulse signal “pul” from the sum of the pulse width obtained in the previous calibration operation and the permitted limit.

In other words, the controller 4 sets the pulse width of the pulse signal “pul” to the sum of the pulse width obtained in the previous calibration operation and the permitted limit in step S1-4′, unlike in step S1-4 of FIG. 10. Thereafter, the pulse width of the pulse signal “pul” is gradually reduced in steps S1-5 and S1-6.

A″ described above, the calibration operation of FIG. 11 aims to obtain the calibrated pulse width appropriate for the current operating conditions like the calibration operation of FIG. 10, but the searchable range of the pulse width is restricted to accelerate the calibration operation.

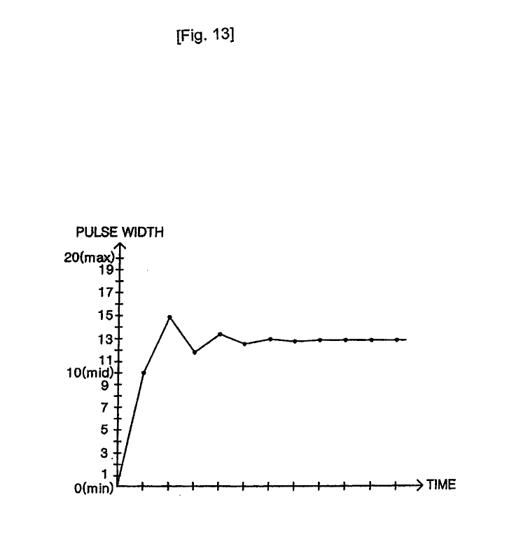

FIG. 12 is a flowchart illustrating a calibration operation (step S10) of FIG. 9 according to yet another exemplary embodiment of the present invention

In FIG. 12, a pulse width appropriate for the current operating conditions may be obtained using a successive approximation method, which is being widely adopted in the analog-to-digital converter (ADC) field.

First, the controller 4 performs the same operations as in steps S1-1 to S1-3 of FIG. 10. Thereafter, the pulse width of the pulse signal “pul” is set to a half “mid” of the maximum value “max”, and a pulse-width change unit Δpul is set to an intermediate value between the half-maximum value “mid” and the maximum value “max” in step S2-1.

When the pulse signal “pul” is not transmitted in step S2-2, the controller 4 increases the pulse width of the pulse signal “pul” by pulse-width change unit Δpul and changes the pulse-width change unit Δpul by half in step S2-3 and returns to step S2-2 again. That is, the controller 4 repeats steps S2-2 and S2-3 until the pulse signal “pul” is transmitted to the controller 4 so that the pulse width of the pulse signal “pul” is gradually increased while increasing.

As a result, when the pulse signal “pul” is finally transmitted in step S2-2, the controller 4 reduces the pulse width of the pulse signal “pul” by the preset pulse-width change unit Δpul and changes the pulse-width change unit Δpul by half in step S2-4 and confirms if the pulse signal “pul” is transmitted in step S2-5. That is, the controller 4 repeats steps S2-4 and S2-5 until the pulse signal “pul” is not transmitted to the controller 4 so that the pulse width of the pulse signal “pul” is gradually decreased.

The controller 4 repeats steps S2-2 and S2-5 several times until the pulse width of the pulse signal “pul” is converged to a specific value in step S2-6, as shown in FIG. 13. Thus, when the pulse width of the pulse signal “pul” is converged to the specific value, the controller 4 obtains the specific value as a critical pulse width in step S2-7.

In step S2-6, the pulse width is converged to the specific value by repeating a process of gradually increasing the pulse width through steps S2-2 and S2-3, as shown in FIG. 13, and a process of gradually decreasing the pulse width through steps S2-4 and S2-5.

The controller 4 confirms if a difference between the current critical pulse width and the critical pulse width obtained in the previous calibration operation exceeds a permitted limit in step S2-8. When the difference between the current critical pulse width and the critical pulse width obtained in the previous calibration operation exceeds the permitted limit, the controller 4 confirms that the calibration is not satisfied and cancels the calibration operation in step S1-2 and ends the control sequence.

On the other hand, when the difference between the current critical pulse width and the critical pulse width obtained in the previous calibration operation is within the permitted limit, the controller 4 confirms that the calibration operation is performed under normal conditions and obtains a calibrated pulse width appropriate for the current operating conditions in step S2-6 by adding a margin pulse width to the current critical pulse width.

Thereafter, the controller 4 calibrates the pulse signal “pul” to the calibrated pulse width in step S2-7, ends the calibration operation, and enters step S11 of FIG. 9.

As described above, the calibration operation of FIG. 12 aims to obtain a calibrated pulse width appropriate for the current operating conditions and calibrate the pulse width of the pulse signal “pul”, like the calibration operation of FIG. 10. It is natural that the decision step whether or not the pulse signal is transmitted can be done by a sequence way such as, not limited, a train of the same pulse width.

According to the present invention as described above, a touch sensor is capable of confirming if a touch object is in contact with a touch pad depending on whether a pulse signal is transmitted or not, so that the touch sensor can perform a touch sensing operation more precisely. Also, the pulse width of the pulse signal is periodically adjusted to operating conditions, thus preventing the occurrence of a malfunction in the touch sensor due to changed operating conditions. As a consequence, the operating reliability of the touch sensor can be enhanced.

While the invention has been shown and described with reference to certain exemplary embodiments thereof, it will be understood by those skilled in the art that various changes in form and details may be made therein without departing from the spirit and scope of the invention as defined by the appended claims.

1. A touch sensor comprising:
a pulse signal generator for generating a pulse signal of which pulse width is calibrated in response to a control code;
a pulse signal transmitter for transmitting the pulse signal when a touch object is out of contact with a touch pad and stopping transmitting the pulse signal when the touch object is in contact with the touch pad;
a pulse signal detector for detecting the pulse signal transmitted through the pulse signal transmitter; and
a controller for recognizing a non-contact state and adjusting the control code to calibrate the pulse width of the pulse signal when the pulse signal detector detects the pulse signal.

2. The touch sensor according to claim 1, wherein the controller obtains a calibrated pulse width at which the pulse signal detector starts detecting the pulse signal by gradually decreasing the pulse width of the pulse signal from a maximum value, and calibrates the pulse width of the pulse signal to the calibrated pulse width.

3. The touch sensor according to claim 1, wherein the controller obtains a calibrated pulse width at which the pulse signal detector starts detecting the pulse signal by gradually decreasing the pulse width of the pulse signal from the sum of a pulse width obtained in the previous calibration operation and a permitted limit, and calibrates the pulse width of the pulse signal to the calibrated pulse width.

4. The touch sensor according to claim 1, wherein the controller obtains a calibrated pulse width at which the pulse signal detector starts detecting the pulse signal using a successive approximation method, and calibrates the pulse width of the pulse signal to the calibrated pulse width.

5. The touch sensor according to claim 4, wherein the successive approximation method comprises obtaining, as the calibrated pulse width, a converged pulse width obtained by repeating a process of gradually increasing the pulse width by a pulse-width change unit and changing the pulse-width change unit by a half when the pulse signal detector does not detect the pulse signal and a process of gradually decreasing the pulse width by the pulse-width change unit and changing the pulse-width change unit by a half when the pulse signal detector detects the pulse signal.

6. The touch sensor according to claim 1, wherein the pulse signal transmitter comprises:
a resistor; and
the touch pad charged or discharged with the pulse signal according to a resistance of the resistor and an electrostatic capacitance of the touch object to inhibit the transmission of the pulse signal when the touch object contacts.

7. The touch sensor according to claim 1, wherein the pulse signal transmitter comprises:
a variable resistor in which resistance varies with the control code; and
the touch pad charged or discharged with the pulse signal according to the varied resistance of the variable resistor and the electrostatic capacitance of the touch object to inhibit the transmission of the pulse signal when the touch object contacts.

8. The touch sensor according to claim 7, wherein the variable resistor comprises:
a plurality of resistors connected in series; and
a plurality of drivers for varying the number of the resistors of the variable resistor to which a clock signal is transmitted in response to the control code.

9. The touch sensor according to claim 1, wherein the pulse signal generator comprises:
a clock signal generator for generating a clock signal; and
a counter of which a counting value is set according to the control code, and counting by the counting value in response to the clock signal to vary the pulse width of the pulse signal.

10. The touch sensor according to claim 9, wherein the pulse signal detector comprises a T-flip-flop for toggling an output signal in response to the pulse signal.

11. The touch sensor according to claim 1, wherein the pulse signal generator comprises:
a clock signal generator for generating a clock signal;
a signal delay unit for varying a delay time of the clock signal according to the control code;
an inverter for inverting an output signal of the signal delay unit; and
a logic gate for performing a logic AND operation on the clock signal and an output signal of the inverter to generate the pulse signal having a pulse width corresponding to the delay time of the clock signal.

12. The touch sensor according to claim 11, wherein the signal delay unit comprises a plurality of delay cells connected in series to correspond to the respective code values of the control code, each delay cell for determining whether the clock signal is delayed or not in response to the corresponding code value of the control code.

13. The touch sensor according to claim 12, wherein each of the delay cells comprises:
a multiplexer for receiving an output signal of a front-end delay cell and the clock signal, selecting one of the output signal of the front-end delay cell and the clock signal in response to the corresponding code value of the control code, and outputting the selected signal; and
an even number of inverters for delaying the clock signal and outputting the delayed clock signal to a rear-end delay cell when the clock signal is transmitted from the multiplexer.

14. The touch sensor according to claim 11, wherein the pulse signal detector comprises a T-flip-flop for toggling an output signal in response to the pulse signal.

15. The touch sensor according to claim 11, wherein the pulse signal detector comprises a D-flip-flop for latching the pulse signal in response to the clock signal.

16. A method of operating a touch sensor, comprising:
generating a pulse signal having a predetermined pulse width;
transmitting the pulse signal when a touch object is out of contact with a touch pad and stopping transmitting the pulse signal when the touch object is in contact with the touch pad;
recognizing a non-contact state when the pulse signal is transmitted and recognizing a contact state when the pulse signal is not transmitted; and
calibrating the pulse width of the pulse signal in the non-contact state.

17. The method according to claim 16, wherein calibrating the pulse width of the pulse signal in the non-contact state comprises:
obtaining a critical pulse width at which the pulse signal is not transmitted by gradually decreasing the pulse width of the pulse signal from the maximum value;
obtaining a calibrated pulse width by adding a margin pulse width to the critical pulse width when a difference between the current critical pulse width and a critical pulse width obtained in the previous calibration operation is within a permitted limit; and
calibrating the pulse width of the pulse signal to the calibrated pulse width.

18. The method according to claim 16, wherein calibrating the pulse width of the pulse signal in the non-contact state comprises:
obtaining a critical pulse width at which the pulse signal is not transmitted by gradually decreasing the pulse width of the pulse signal from the sum of a pulse width obtained in the previous calibration operation and a permitted limit;
obtaining a calibrated pulse width by adding a margin pulse width to the critical pulse width when a difference between the current critical pulse width and a critical pulse width obtained in the previous calibration operation is within the permitted limit; and
calibrating the pulse width of the pulse signal to the calibrated pulse width.

19. The method according to claim 16, wherein calibrating the pulse width of the pulse signal in the non-contact state comprises:
obtaining a critical pulse width by increasing and decreasing the pulse width of the pulse signal using a successive approximation method;
obtaining a calibrated pulse width by adding a margin pulse width to the critical pulse width when a difference between the current critical pulse width and a critical pulse width obtained in the previous calibration operation is within a permitted limit; and
calibrating the pulse width of the pulse signal to the calibrated pulse width.

20. The method according to claim 19, wherein obtaining the critical pulse width comprises:
initializing the pulse width of the pulse signal and a pulse-width change unit;
converging the pulse width by repeating a process of gradually increasing the pulse width by the pulse-width change unit and changing the pulse-width change unit by a half when the pulse signal is not transmitted and a process of gradually decreasing the pulse width by the pulse-width change unit and changing the pulse-width change unit by a half when the pulse signal is transmitted; and
obtaining the converged pulse width as the critical pulse width.
